(19) United States
(12) Patent Application Publication
(10) Pub. No.: US 2017/0229811 A1
(43) Pub. Date: Aug. 10, 2017

(54) DEVICE FOR ETHERNET CONNECTOR REPAIR

(71) Applicants: Antonio F. Clark, Woodland Hills, CA (US); Michelle A. Clark, Woodland Hills, CA (US)

(72) Inventors: Antonio F. Clark, Woodland Hills, CA (US); Michelle A. Clark, Woodland Hills, CA (US)

(21) Appl. No.: 15/019,147

(22) Filed: Feb. 9, 2016

(51) Int. Cl. H01R 13/627; H01R 24/64

(52) U.S. Cl. CPC H01R 13/6275; H01R 24/64

(57) ABSTRACT

A device for Ethernet connector repair that includes: a sleeve adapted for placement over an Ethernet connector; a lip extending from the sleeve; a clip on a distal end of the lip along a top surface of the lip, where clip is adapted to replace a missing clip on the Ethernet connector; and a clamp, where the clamp secures the sleeve to a cable of the Ethernet connector. The clamp preferably includes a first side and a second side that enables the clamp to toggle between a first position and a second position. The first position is adapted for placement over the cable and the second position is adapted for securing the sleeve to the cable, where first position is an open position and the second position is a closed position.

### BACKGROUND OF THE INVENTION

Field of Invention

The present invention relates to a device that repairs a damaged Ethernet connector.

Description of Related Art

Ethernet cables and connectors are used in information networking systems to connect various computing components. Ethernet connector cables are commonly used to connect a computer to a router and any other connections between routers and networking components. The Ethernet cable includes a connector in the form of a plastic clip that inserts and locks the cable into the connection with a computer or a router. The clip is resiliently flexible and secures the connector into place. One drawback to this connector is that the clip is frequently broken or damaged therefore compromising the connection between the cable and computer or router. Although the connection may be made without the clip the connector is subject to easy disconnection and therefore can affect the overall Ethernet connection with the Ethernet cable. Information technology professionals normally have to replace entire cables in situations where the connector or the clip on the connector has been broken. Although some solutions have been developed for replacement and repair of this clip many of these repair devices are quite complex and not as effective as the original clip.

### SUMMARY OF THE INVENTION

The present invention relates to a device for Ethernet connector repair that includes: a sleeve adapted for placement over an Ethernet connector; a lip extending from the sleeve; a clip on a distal end of the lip along a top surface of the lip, where clip is adapted to replace a missing clip on the Ethernet connector; and a clamp, where the clamp secures the sleeve to a cable of the Ethernet connector. The clamp preferably includes a first side and a second side that enables the clamp to toggle between a first position and a second position. The first position is adapted for placement over the cable and the second position is adapted for securing the sleeve to the cable, where first position is an open position and the second position is a closed position.

### BRIEF DESCRIPTION OF DRAWINGS

FIG. 1 depicts an Ethernet cable and connector in accordance with the prior art.

FIG. 2 depicts a prior art Ethernet connector with a missing connection clip.

FIG. 3 depicts a sleeve in accordance with the present invention.

FIG. 4 depicts a back view of the sleeve connected to an Ethernet cable.

FIG. 5 depicts a side view of the sleeve according to the present invention attached to an Ethernet connector.

### DETAILED DESCRIPTION

The present invention relates to a device that fits over an Ethernet connector to provide a functioning clip to enable the connection to function properly. Many times Ethernet connectors are damaged and made ineffective when a small clip is broken from the connector. The present invention provides a device in the form of a sleeve that slides over the Ethernet connector and clamps onto the cable to secure the sleeve in place. The sleeve includes a lip that extends over the top surface of an Ethernet connector and a functioning clip on the top surface of the lip. As a result the device according to the present invention repairs the Ethernet connector and replaces the clip for effective use of the Ethernet cable.

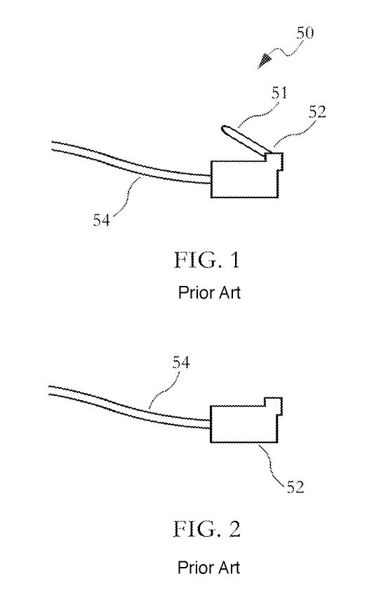

In reference to FIG. 1, an Ethernet cable 50 is shown. The Ethernet cable 50 includes cable 54 that has a connector 52 attached to the end of the cable 54. The connector 52 includes a clip 51 and extends from the top surface of the connector 52. The clip 51 may be easily damaged or broken and therefore making the connector 52 essentially ineffective in securing a connection with a computer or router. FIG. 2 depicts the Ethernet connector 52 without clip 51.

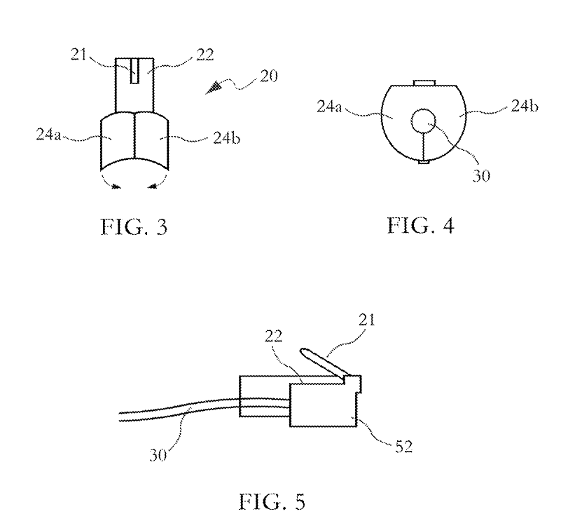

A sleeve 20 is shown in FIG. 3 that fits over the Ethernet connector to provide a replacement clip. Sleeve 20 includes a clamp 24a, 24b, where 24a designates a first side of the clamp and 24b designates a second side of the clamp. A lip 22 extends from clamp 24a, 24b that includes a clip 21 along the top surface of the lip 22. The clip 21 is provided at the distal end of the lip 22. FIG. 4 shows the clamp 24a, 24b in a closed position around a cable 30. This secures the sleeve 20 onto the Ethernet connector and enables the placement of a clip in an appropriate position on the top surface of the connector.

FIG. 5 shows a side view of the clip 20 attached to an Ethernet connector 52. As shown, the lip 22 extends across the top surface of the connector 52 placing the clip 21 in a suitable position for use in conjunction with the connector 52. The clamp 24a, 24b clamps around cable 30 and secures the sleeve 20 in position over the connector 52. The present invention provides a device that ensures a quick and effective means to repair a damaged Ethernet connector. The instant invention has been shown and described in what it considers to be the most practical and preferred embodiments. It is recognized, however, that departures may be made there from within the scope of the invention and that obvious modifications will occur to a person skilled in the art.

1. (canceled)

2. (canceled)

3. (canceled)

4. (canceled)

5. A sleeve for Ethernet connector repair comprising:
a. a clamp, where said clamp includes a first pivoting side and a second pivoting side and the first pivoting side and second pivoting side pivot between an open position to a closed position, where the clamp is adapted to secure the sleeve to a cable of the Ethernet connector in the closed position;
b. a lip extending from the clamp; and
c. a clip on a distal end of the lip along a top surface of the lip, where clip is adapted to replace a missing clip on the Ethernet connector.
